(19) United States
(12) Patent Application Publication
(10) Pub. No.: US 2024/0220784 A1
(43) Pub. Date: Jul. 4, 2024

(54) SYNAPTIC ARRAY DEVICE AND ARTIFICIAL NEURAL NETWORK LEARNING METHOD USING IT

(71) Applicant: POSTECH Research and Business Development Foundation, Pohang-si (KR)

(72) Inventors: Seyoung KIM, Pohang-si (KR); Doyoon KIM, Goyang-si (KR)

(21) Appl. No.: 18/381,273

(22) Filed: Oct. 18, 2023

(30) Foreign Application Priority Data
Dec. 28, 2022 (KR) 10-2022-0187082

(51) Int. Cl. G06N 3/063

(52) U.S. Cl. CPC G06N 3/063

(57) ABSTRACT

A synaptic array device according to one embodiment of the present disclosure comprises a first synaptic array representing weight values, a second synaptic array receiving the error gradient of the weights of the first synaptic array and representing gradient values refined in row units, and a third synaptic array receiving the gradient values refined in row units from the second synaptic array and passing the portion of the received gradient values exceeding a threshold to the first synaptic array, wherein the third synaptic array derives a moving average value by averaging accumulated values of the gradient values received from the second synaptic array and passes the derived moving average value to the second synaptic array.

### TECHNICAL FIELD

The present disclosure relates to a synaptic array device that reduces the convergence error of a main matrix by utilizing the average value of a matrix of accumulated gradients in the synaptic array device exhibiting a non-symmetric operational tendency and an artificial neural network learning method using the device.

### BACKGROUND

Recently, extensive research efforts have been made in various directions on neuromorphic devices, which implement neural networks using specialized hardware. The neuromorphic device imitates the structure of neurons and synapses constituting the brain-nervous system of a living body and generally comprises pre-synaptic neurons located before synapses, synapses, and post-synaptic neurons located after synapses. A synapse is a connection point between neurons and performs the function of updating and memorizing a synaptic weight according to a spike signal generated by both neurons.

Generally, when training a neural network using a synaptic array device, updating synaptic elements with accurate weights is essential to increase learning performance. Therefore, the conductance values updated for a synaptic device at the time of update should match target values. However, in the cases of synaptic devices under active research, such as Resistive RAM (ReRAM), Phase Change Memory (PCM), Ferroelectric RAM (FeRAM), and Electrochemical RAM (ECRAM), even when the devices have the same conductance value, the amount of conductance updated at a time varies according to the increment or decrement direction of conductance. This behavior is referred to as a non-symmetric update characteristic of the device; the non-symmetric update characteristic prevents accurate weight values from being stored in the device, which is a primary cause of deterioration of neural network learning performance. However, since the above behavior is a physical property resulting from the structure of a synaptic device and the conductance change mechanism due to the structure, research is currently underway to improve the non-symmetric update behavior of synaptic devices.

### PRIOR ART REFERENCES

### Patents

Korea laid-open patent No. 10-2020-0100286 (Aug. 26, 2020)

### SUMMARY

One embodiment of the present disclosure provides a synaptic array device and an artificial neural network learning method using the device, wherein the synaptic array device avoids the occurrence of a weight computation error even when the symmetry point—where weight increment and decrement strengths are equal—is not set to 0 in the non-ideal device by applying, to synaptic devices, an artificial neural network learning method employing an algorithm of calculating the average value of accumulated values and subtracting the average value from the weights.

One embodiment of the present disclosure provides a synaptic array device and an artificial neural network learning method using the device, wherein the synaptic array device further simplifies the update process and reduces potential errors, thereby helping to ensure learning performance closer to that of digital implementation when an analog neural network accelerator is implemented.

A synaptic array device according to one embodiment of the present disclosure comprises a first synaptic array representing weight values, a second synaptic array receiving the error gradient of the weights of the first synaptic array and representing gradient values refined in row units, and a third synaptic array receiving the gradient values refined in row units from the second synaptic array and passing the portion of the received gradient values exceeding a threshold to the first synaptic array, wherein the third synaptic array derives a moving average value by averaging accumulated values of the gradient values received from the second synaptic array and passes the derived moving average value to the second synaptic array.

The first synaptic array and the second synaptic array use analog array devices, and the third synaptic array is allocated on the digital domain.

As a training process is repeated on the first synaptic array, the second synaptic array, and the third synaptic array, the second synaptic array converges to ‘0’, and the gradient value becomes close to ‘0’.

When the moving average value is passed to the second synaptic array, the moving average value may be updated continuously to be set as an offset.

The moving average value may be calculated in the form of adding an existing average value and a new value of the second synaptic array at a specific ratio, wherein the specific ratio is maintained constant or varied to adjust the degree of convergence.

In an artificial neural network learning method using a synaptic array device comprising a first synaptic array and a second synaptic array using analog array devices and a third synaptic array allocated on the digital domain, an artificial neural network learning method according to one embodiment of the present disclosure comprises passing the error gradient of the weights of the first synaptic array to the second synaptic array; refining the error gradient in row units through the second synaptic array and passing the corresponding gradient value to the third synaptic array; and deriving a moving average value by averaging accumulated values of the gradient values received from the second synaptic array through the third synaptic array and passing the moving average value again to the second synaptic array.

The second synaptic array may be initialized to a symmetry point or to a value different from the symmetry point.

The moving average value is calculated by Eq. 1 below.

$$moving average = moving average * \frac{window - 1}{window} + A * \frac{1}{window} \qquad [ Eq . 1 ]$$

The window value of Eq. 1 may be adjusted to control the degree of convergence, wherein the window value may be constant or a value that varies continuously by using a moving average value or a function employing the values of the first and second synaptic arrays depending on epochs.

The passing of the corresponding gradient value to the third synaptic array updates the moving average value continuously to process the moving average value as an offset.

Whenever the update is performed, periodic attenuation may be introduced, wherein the periodic attenuation defines a gamma parameter between 0 and 1 and multiplies the moving average value by the gamma parameter to reduce the moving average value.

The present disclosure may provide the following effects. However, since it is not meant that a specific embodiment has to provide all of or only the following effects, the technical scope of the present disclosure should not be regarded as being limited by the specific embodiment.

A synaptic array device and an artificial neural network learning method according to one embodiment of the present disclosure provides an effect of avoiding the occurrence of a weight computation error even when the symmetry point—where weight increment and decrement strengths are equal—is not set to 0 in the non-ideal device by applying, to synaptic devices, an artificial neural network learning method employing an algorithm of calculating the average value of accumulated values and subtracting the average value from the weights.

A synaptic array device and an artificial neural network learning method according to one embodiment of the present disclosure may further simplify the update process and reduces potential errors, thereby helping to ensure learning performance closer to that of digital implementation when an analog neural network accelerator is implemented.

### BRIEF DESCRIPTION OF THE DRAWINGS

FIG. 1 shows a structure of a typical artificial neural network.

FIG. 2 shows an example of an analog RPU that implements an artificial neural network.

FIGS. 3A-3C illustrate update behavior of an analog synaptic device.

FIGS. 4A and 4B illustrate the structure of an algorithm (Tiki-Taka) capable of compensating for non-idealities.

FIGS. 5A and 5B illustrate a simulation result of the operation of matrix A and matrix C when the algorithm of FIGS. 4A and 4B is applied.

FIG. 6 shows a structure of an algorithm according to one embodiment of the present disclosure.

FIGS. 7 and 8 show the algorithm of FIG. 6 in sequential order.

FIGS. 9A and 9B illustrate the operational characteristics of the first synaptic array and the second synaptic array according to the algorithm operation of FIG. 6.

### DETAILED DESCRIPTION

Since the description of the present disclosure is merely an embodiment for structural or functional explanation, the scope of the present disclosure should not be construed as being limited by the embodiments described in the text. That is, since the embodiments may be variously modified and may have various forms, the scope of the present disclosure should be construed as including equivalents capable of realizing the technical idea. In addition, a specific embodiment is not construed as including all the objects or effects presented in the present disclosure or only the effects, and therefore the scope of the present disclosure should not be understood as being limited thereto.

On the other hand, the meaning of the terms described in the present application should be understood as follows.

Terms such as “first” and “second” are intended to distinguish one component from another component, and the scope of the present disclosure should not be limited by these terms. For example, a first component may be named a second component and the second component may also be similarly named the first component.

It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. Meanwhile, other expressions describing a relationship between components, that is, “between,” “directly between,” “neighboring to,” “directly neighboring to,” and the like, should be similarly interpreted.

It should be understood that the singular expression includes the plural expression unless the context clearly indicates otherwise, and it will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Identification symbols (for example, a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices storing data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

In what follows, preferred embodiments of the present disclosure will be described in detail with reference to appended drawings. In what follows, the same reference symbols are used for the same constituting elements of the drawings, and repeated descriptions of the same constituting elements will be omitted.

On-device training through analog deep neural network operation may perform the matrix operation, which occupies the largest portion of neuromorphic operations, directly on the memory. The above scheme may solve the hassle of transferring data from the memory and the arithmetic unit installed on a different part of the existing computer structure, thereby enabling low-power and high-efficiency computation. However, the device specifications required to implement the above architecture are highly demanding and mandate a reduction in the non-ideal portion; since the devices proposed so far have failed to satisfy the required specifications, a simplified algorithm capable of implementing low-power, high-efficiency on-device training is still needed.

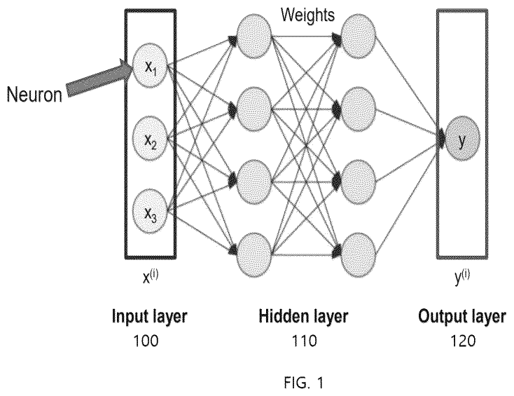

FIG. 1 shows a structure of a typical artificial neural network.

Referring to FIG. 1, an artificial neural network comprises an input layer 100, a hidden layer 110, and an output layer 120. A layer refers to a unit formed by the gathering of many neurons, and a fully connected layer structure connects all instances of the respective layers. In the fully connected layer, neurons of the input layer and neurons of the output layer are connected in a way to support the same number of connections that may be realized between the input and output layers.

The input layer receives input data and passes them to the next layer, the hidden layer, which is a fully connected layer connected to the input layer and may be considered an essential layer in solving complex problems. Following the hidden layer, the output layer is also a fully connected layer responsible for transmitting output signals to the outside of the neural network, where the activation function employed in the output layer determines the function of the neural network.

The training process comprises a forward pass and a backward pass. During the forward pass, incoming input data traverses the hidden layer 110 and emerges from the output layer 120. Meanwhile, the error gradient is delivered to each neuron through the backward pass, after which an update is performed.

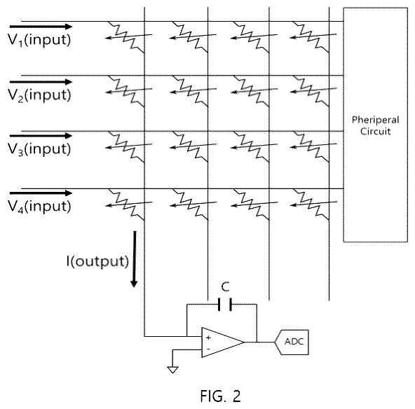

FIG. 2 shows an example of an analog Resistive Processing Unit (RPU) that implements an artificial neural network.

Referring to FIG. 2, each RPU possesses conductance that represents a weight responsible for performing matrix operations within a neural network. The RPU carries out these operations using Ohm's law and Kirchhoff's current law, while peripheral digital circuits implement other computations.

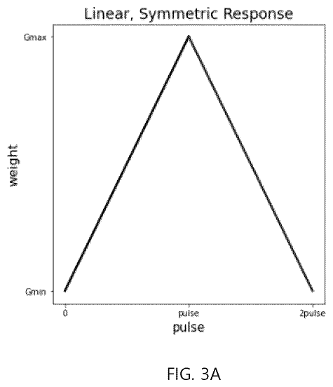

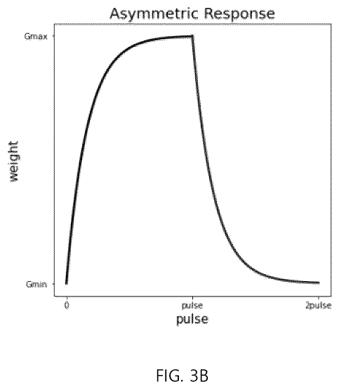

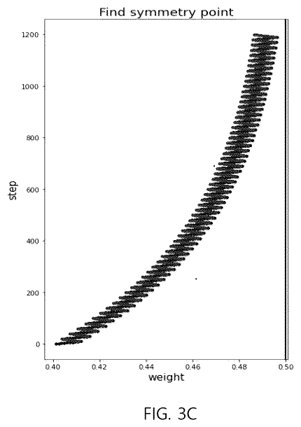

FIGS. 3A-3C illustrate update behavior of an analog synaptic device, where FIG. 3A shows the update behavior of an ideal analog synaptic device, and FIG. 3B shows the update behavior of a typical analog synaptic device.

First, referring to FIG. 3A, an ideal analog synaptic device should demonstrate perfectly symmetric update behavior in both the increment (+) and decrement (−) directions; exhibit significantly low noise, retention, and variance; and possess an ample number of states.

However, as shown in FIG. 3B, an actual analog synaptic device demonstrates update behavior differently in the (+) and (−) directions and, moreover, exhibits non-idealities in terms of noise, retention, variance, and the number of states. To address the non-linear characteristics, it is necessary to perform operations after finding a symmetry point, where weight increment and decrement strengths are equal, and setting the symmetry point as the ‘0’ point. FIG. 3C shows a process of finding a point where the update behavior becomes symmetric. When an increment and a decrement are performed once or repeated by the same amount at an arbitrary point, the weight value converges to a symmetry point. Since the increment and decrement strengths are different at a point other than the symmetry point, repeating a single step of increment and decrement causes the weight to move in a specific direction, which is directed toward the symmetry point.

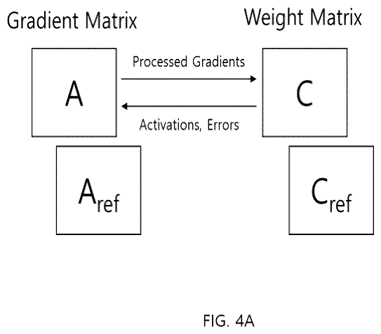

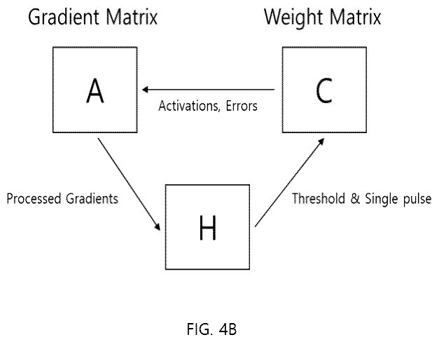

FIGS. 4A and 4B illustrate the structure of an algorithm (Tiki-Taka) capable of compensating for non-idealities.

First, referring to FIG. 4A, the corresponding algorithm utilizes two matrices: matrix C, which serves as a main array, and matrix A, which acts as a sub-array representing the gradient values; the algorithm involves updating matrix A using the gradient values of matrix C and updating matrix C using a portion of the values of matrix A during each particular epoch based on a specific learning ratio.

Also, FIG. 4B illustrates a new algorithm (Tiki-Taka v2) which improves the tolerance against the non-idealities by introducing a new matrix to the algorithm of FIG. 4A. The new algorithm is based on a structure in which matrix H is allocated to the digital domain and updated by receiving the values of matrix A, and if the corresponding value is larger than or equal to a specific threshold value, the value is passed to matrix C.

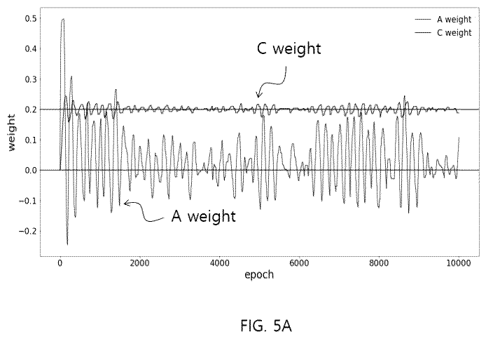

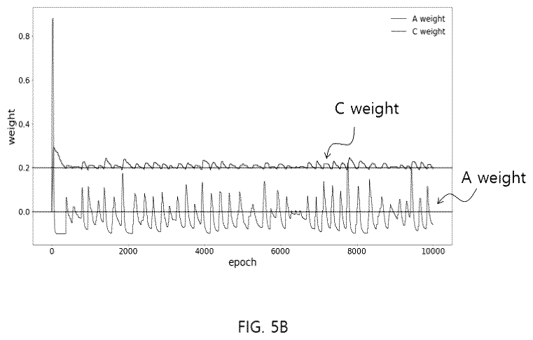

FIGS. 5A and 5B illustrate a simulation result of the operation of matrix A and matrix C when the algorithm of FIGS. 4A and 4B is applied.

Referring to FIG. 5A, matrix A converges to 0 regardless of a target value set for a non-symmetric device. Since matrix A represents the gradient values of the device, the above characteristic also indicates that matrix C converges to the target value.

On the other hand, FIG. 5B shows a simulation result when the ‘0’ point of matrix A does not coincide with the symmetry point. As the training of matrix A is repeated, matrix A tends to converge to a symmetry point rather than the 0 point. In other words, it means that the gradient value converges to a point other than 0, which indicates that an error occurs in the value of matrix C. Therefore, it is necessary to use the symmetry point shifting technique to set the symmetry point of matrix A to the 0 point.

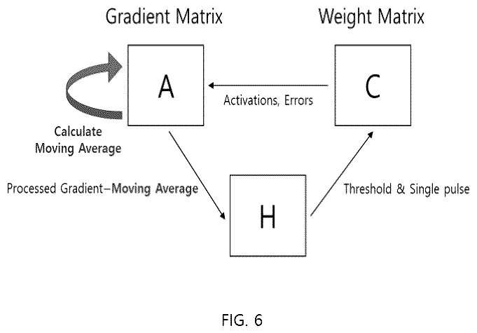

FIG. 6 shows a structure of an algorithm according to one embodiment of the present disclosure.

Referring to FIG. 6, a synaptic array device according to the present disclosure comprises a first synaptic array C, which serves as a main array, and a second synaptic array A, which acts as a sub-array. Also, the synaptic array device further includes a third synaptic array H which derives a moving average value by averaging accumulated values received from the second synaptic array A and delivers the moving average value again to the second synaptic array A. At this time, the first synaptic array C and the second synaptic array A use two analog array devices, and the third synaptic array H is allocated on the digital domain.

The first synaptic array C represents weight values, and the second synaptic array A represents the gradient values obtained by receiving the error gradients of the weight values of the first synaptic array C and refining the received error gradients in row units.

Also, the third synaptic array H receives the gradient values refined in row units from the second synaptic array A. The third synaptic array H passes a portion of the received gradient values which exceeds a threshold value to the first synaptic array C and removes the corresponding values during each epoch.

As the training process is repeated among the first synaptic array C, the second synaptic array A, and the third synaptic array H, the second synaptic array A converges to 0, and the gradient value becomes close to 0. The first synaptic array C converges to the actual value to compensate for the non-idealities of the device.

The third synaptic array H derives a moving average value by averaging accumulated values received from the second synaptic array A and delivers the moving average value again to the second synaptic array A. At this time, the moving average value may be calculated in the form of adding the existing average value and a new value of the second synaptic array A at a specific ratio, wherein the specific ratio is maintained constant or varied to adjust the degree of convergence. When the average value is delivered to the second synaptic array, the moving average value is updated continuously to process the moving average value as an offset; whenever the update is performed, periodic attenuation may be introduced to prevent divergence from occurring in the non-symmetric device. The periodic attenuation defines a gamma parameter between 0 and 1 and multiplies the moving average value by the gamma parameter to reduce the moving average value.

The moving average value should be optimized according to the device's characteristics; if an appropriate weight is selected, a smooth curve is drawn so that the updated value may quickly converge to a single point.

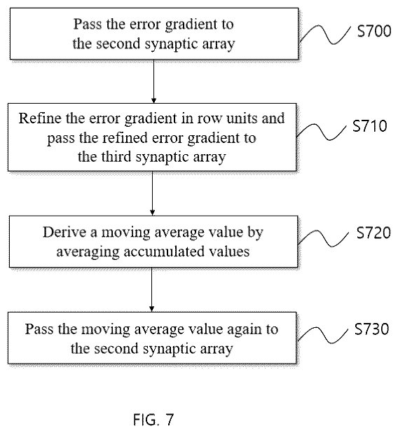

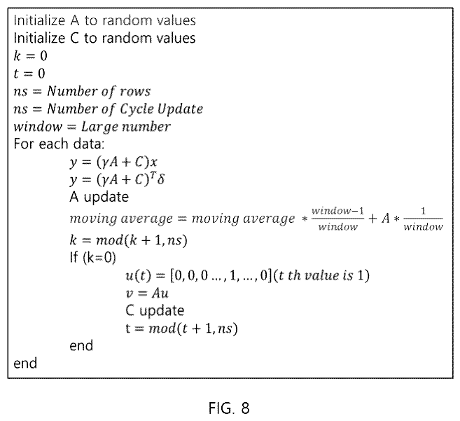

FIGS. 7 and 8 show the algorithm of FIG. 6 in sequential order.

Referring to FIGS. 7 and 8, in an artificial neural network learning method using a synaptic array device comprising a first synaptic array and a second synaptic array, which are analog array devices, and a third synaptic array allocated on the digital domain, the error gradients of weights in the first synaptic array are delivered to the second synaptic array S700.

Next, the error gradients are refined in row units through the second synaptic array, and the corresponding gradients are passed to the third synaptic array S710. Next, a moving average value is derived by averaging the accumulated values of the gradients received from the second synaptic array through the third synaptic array S720, and the moving average value is again delivered to the second synaptic array S730. At this time, the moving average value may be calculated by Eq. 1 below and updated when it is passed to the first synaptic array C or the third synaptic array H.

$$moving average = moving average * \frac{window - 1}{window} + A * \frac{1}{window} \qquad [ Eq . 1 ]$$

The moving average value is obtained by adding the existing average value and a new value of the second synaptic array at a specific ratio, where the ratio may be defined as a window. Also, the moving average algorithm may include simple averaging or all the other processes of changing the reflection ratio in various ways.

The window value of Eq. 1 may be adjusted to control the degree of convergence, wherein the window value may be constant or a value that varies continuously by using a moving average value or a function employing the values of the first and second synaptic arrays depending on epochs.

In addition, although the initialization process of the second synaptic array A in the existing algorithms requires moving to the symmetry point and setting the symmetry point to 0, the algorithm shown in FIG. 6 does not necessarily require moving to the symmetry point and setting the symmetry point to 0. In other words, according to the present disclosure, the algorithm may omit the process of finding the symmetry point where the increment and decrement strengths are the same and setting the corresponding point to 0.

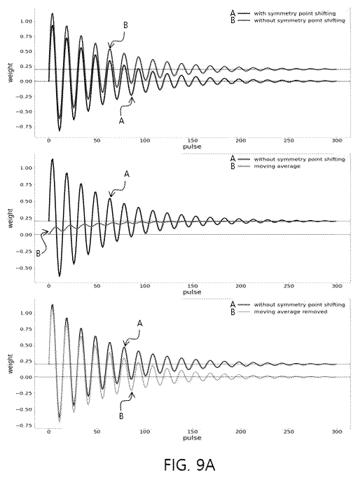

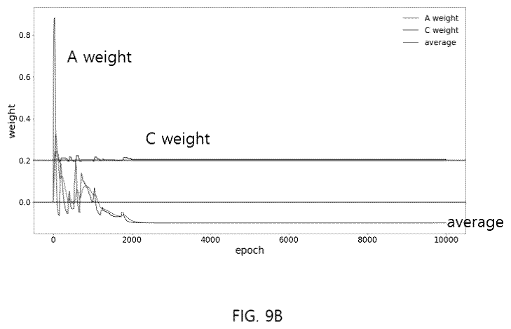

FIGS. 9A and 9B illustrate the operational characteristics of the first synaptic array and the second synaptic array according to the algorithm operation of FIG. 6.

First, FIG. 9A shows the operational behavior of the second synaptic array A when the algorithm of FIG. 6 is applied. Without shifting to the symmetry point, the weights of the second synaptic array A converge to the point different from 0. At this time, since the moving average value also converges to the same point, weights converge to the 0 if the moving average value is removed.

FIG. 9B is a simulation result showing the actual operational behavior of the first synaptic array C and the second synaptic array A when the algorithm of FIG. 6 is applied. The corresponding algorithm causes the first synaptic array C to converge to a correct value without symmetry point setting and causes the weights to converge more quickly than existing algorithms.

As described above, the present disclosure eliminates the need for a symmetry point setting process, which involves calculating a moving average value of the matrix values accumulated in the third synaptic array H from the second synaptic array A and using the moving average value as an offset. The present disclosure significantly simplifies the algorithm and thus makes the learning process of an artificial neural network much more straightforward.

[Detailed Description of Main Elements]

100: Input layer
110: Hidden layer
120: Output layer
A: Second synaptic array
C: First synaptic array
H: Third synaptic array

What is claimed is:

1. A synaptic array device comprising:
a first synaptic array representing weight values;
a second synaptic array receiving the error gradient of the weights of the first synaptic array and representing gradient values refined in row units; and
a third synaptic array receiving the gradient values refined in row units from the second synaptic array and passing the portion of the received gradient values exceeding a threshold to the first synaptic array,
wherein the third synaptic array derives a moving average value by averaging accumulated values of the gradient values received from the second synaptic array and passes the derived moving average value to the second synaptic array.

2. The device of claim 1, wherein the first synaptic array and the second synaptic array use analog array devices, and the third synaptic array is allocated on the digital domain.

3. The device of claim 1, wherein, as a training process is repeated on the first synaptic array, the second synaptic array, and the third synaptic array, the second synaptic array converges to ‘0’, and the gradient value becomes close to ‘0’.

4. The device of claim 1, wherein, when the moving average value is passed to the second synaptic array, the moving average value is updated continuously to be set as an offset.

5. The device of claim 1, wherein the moving average value is calculated in the form of adding an existing average value and a new value of the second synaptic array at a specific ratio, wherein the specific ratio is maintained constant or varied to adjust the degree of convergence.

6. In an artificial neural network learning method using a synaptic array device comprising a first synaptic array and a second synaptic array using analog array devices and a third synaptic array allocated on the digital domain, the artificial neural network learning method comprising:
passing the error gradient of the weights of the first synaptic array to the second synaptic array;
refining the error gradient in row units through the second synaptic array and passing the corresponding gradient value to the third synaptic array; and
deriving a moving average value by averaging accumulated values of the gradient values received from the second synaptic array through the third synaptic array and passing the moving average value again to the second synaptic array.

7. The method of claim 6, wherein the second synaptic array is initialized to a symmetry point or to a value different from the symmetry point.

8. The method of claim 1, wherein the moving average value is calculated by Eq. 1 below.
$$moving average = moving average * \frac{window - 1}{window} + A * \frac{1}{window} \qquad [ Eq . 1 ]$$

9. The method of claim 8, wherein the window value of Eq. 1 is adjusted to control the degree of convergence, wherein the window value is constant or a value that varies continuously by using a moving average value or a function employing the values of the first and second synaptic arrays depending on epochs.

10. The method of claim 6, wherein the passing of the corresponding gradient value to the third synaptic array updates the moving average value continuously to process the moving average value as an offset.

11. The method of claim 10, wherein, whenever the update is performed, periodic attenuation is introduced, wherein the periodic attenuation defines a gamma parameter between 0 and 1 and multiplies the moving average value by the gamma parameter to reduce the moving average value.
